(19) United States
(12) Patent Application Publication
(10) Pub. No.: US 2016/0147408 A1
(43) Pub. Date: May 26, 2016

(54) VIRTUAL MEASUREMENT TOOL FOR A WEARABLE VISUALIZATION DEVICE

(71) Applicants: Johnathan Bevis, Redmond, WA (US); Nicholas Fajt, Seattle, WA (US); David Hill, Bellevue, WA (US); Brian Murphy, Seattle, WA (US); Jon Paulovich, Redmond, WA (US); Michael Thomas, Redmond, WA (US)

(72) Inventors: Johnathan Bevis, Redmond, WA (US); Nicholas Fajt, Seattle, WA (US); David Hill, Bellevue, WA (US); Brian Murphy, Seattle, WA (US); Jon Paulovich, Redmond, WA (US); Michael Thomas, Redmond, WA (US)

(21) Appl. No.: 14/610,999

(22) Filed: Jan. 30, 2015

Related U.S. Application Data
(63) Continuation of application No. 14/553,668, filed on Nov. 25, 2014, now abandoned.

(51) Int. Cl. G06F 3/0481; G02B 27/01; G06F 3/01

(52) U.S. Cl. CPC G06F 3/04815; G06F 3/013; G02B 27/017; G06F 3/017; G02B 2027/0178

(57) ABSTRACT

Disclosed are a technique of generating and displaying a virtual measurement tool in a wearable visualization device, such as a headset, glasses or goggles equipped to provide an augmented reality and/or virtual reality experience for the user. In certain embodiments, the device generates the tool by determining multiple points, each at a different location in a three-dimensional space occupied by the user, based on input from the user, for example, by use of gesture recognition, gaze tracking and/or speech recognition. The device displays the tool so that the tool appears to the user to be overlaid on a real-time, real view of the user's environment.

This is a continuation of U.S. patent application Ser. No. 14/553,668, filed on Nov. 25, 2014, which is incorporated herein by reference in its entirety.

### FIELD OF THE INVENTION

At least one embodiment of the present invention pertains to display related technology, and more particularly, to a virtual measurement tool for a wearable visualization device, such as an augmented reality or virtual reality display device.

### BACKGROUND

For thousands of years humans have invented and relied on various types of measurement tools to quantify and better understand their environment. To measure relatively short spatial distances, for example, the ruler has been relied upon for centuries. The tape measure is a modern adaptation of the ruler, which was followed more recently by the invention of the laser ruler and other active measurement tools.

However, simple spatial measurement tools that are affordable by the average person, such as traditional rulers, tape measures and laser rulers, have certain shortcomings. For example, they lack the ability to perform more complex measurements, such as area and volume measurements. Also, in many situations a person may wish to measure an object in one location and determine if it will fit into another location. For example, a person may want to buy a new piece of furniture for his home. Typically in that situation, the person would measure the available space in his home and then go to the furniture store and measure the pieces of furniture of interest to determine whether they will fit into that space (or vice versa). In that case, the person needs to either remember or write down the dimensions of the available space (or the item of furniture), which is inconvenient.

### SUMMARY

The technology introduced here includes a technique of generating and displaying a virtual measurement tool (also called simply “the tool” in the following description) in a wearable visualization device, such as a headset, glasses or goggles equipped to provide an augmented reality and/or virtual reality (“AR/VR”) experience for the user. In certain embodiments, the device generates the tool by determining multiple points, each at a different location in a three-dimensional (3D) space (environment) occupied by the user (e.g., a room), based on input from the user, for example, by use of gesture recognition, gaze tracking, speech recognition, or some combination thereof. The device displays the tool so that the tool appears to the user to be overlaid on a real-time, real-world view of the user's environment.

In various embodiments the tool may appear to the user as a holographic ruler or similar measurement tool. The points used to define the tool can be anchored to different points in the 3D space, so that the tool appears to the user to remain at a fixed location and orientation in space even if the user moves through that 3D space. At least one of the points may be anchored to a corresponding point on a physical object. Through gesture recognition, gaze tracking and/or speech recognition, for example, the user can also move the tool in any of six degrees of freedom (e.g., in translation along or rotation about any of three orthogonal axes) and can specify or adjust the tool's size, shape, units, and other characteristics.

In some instances the tool may be displayed as essentially just a line or a very thin rectangle between two user-specified points in space. However, in other instances the tool can take the form of a two-dimensional (2D) polygon that has vertices at three or more user-specified points, or a 3D volume that has vertices at four or more user-specified points. In any of these embodiments, the tool, as displayed to the user, can include a scale including values and units. Additionally, the device can automatically compute and display to the user the value of a length between any two of the determined points, the value of an area between any three or more of the determined points, or the value of a volume between any four or more of the determined points. Further, in certain embodiments the device allows the user to save the state of the tool in memory, including any corresponding measurement values and settings, and reload/redisplay it at a different location.

The device can include a depth camera or other similar sensor to measure distances from the device to objects in the 3D space occupied by the user (e.g., a room). Based on that distance information, the device can generate a 3D mesh model of surfaces in that 3D space, and can use the 3D mesh model to determine spatial coordinates of the plurality of determined points. One or more of the plurality of determined points can be spatially associated with one or more of the objects in the 3D space.

Other aspects of the technique will be apparent from the accompanying figures and detailed description.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

One or more embodiments of the present invention are illustrated by way of example and not limitation in the figures of the accompanying drawings, in which like references indicate similar elements.

FIG. 1 illustrates an example of an AR/VR headset.

FIG. 2 is a high-level block diagram of certain components of an AR/VR headset.

FIGS. 3A through 3M show various examples of a user's view through an AR/VR headset.

FIG. 4 illustrates an example of a process that can be performed by the headset in relation to the virtual measurement tool.

FIG. 5 illustrates an example of the process of providing the virtual measurement tool in greater detail.

FIG. 6 illustrates a process of generating and displaying the virtual measurement tool in greater detail, according to an example scenario.

### DETAILED DESCRIPTION

In this description, references to “an embodiment”, “one embodiment” or the like, mean that the particular feature, function, structure or characteristic being described is included in at least one embodiment of the technique introduced here. Occurrences of such phrases in this specification do not necessarily all refer to the same embodiment. On the other hand, the embodiments referred to also are not necessarily mutually exclusive.

The technology introduced here includes a wearable visualization device that generates and displays a virtual (e.g., holographic) measurement tool (“the tool”), such as a holographic ruler. The visualization device can be, for example, a headset, glasses or goggles equipped to provide the user with an AR/VR experience. The tool enables the user (e.g., wearer) of the device to easily measure distances, areas and volumes associated with objects or spaces in his vicinity. The device enables the user to use and manipulate the tool easily with, for example, gestures, eye gaze or speech, or any combination thereof. The user can customize the tool to whatever length, size, or shape he needs. Additionally, the state of the tool can be saved in memory and reloaded/redisplayed in a different environment.

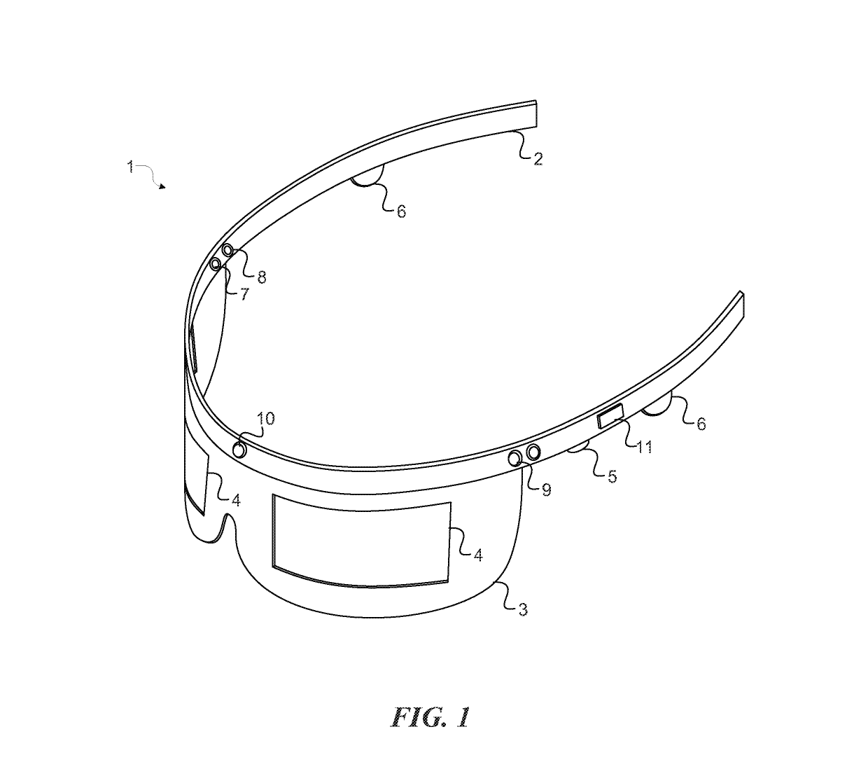

FIG. 1 shows an example of an AR/VR headset that can provide the virtual measurement tool in accordance with the techniques introduced here. Note, however, that the techniques introduced here can be implemented in essentially any type of visualization device that allows machine-generated images to be overlaid (superimposed) on a real-time, real-world view of the user's environment. The illustrated headset 1 includes a headband 2 by which the headset 1 can be removably mounted on a user's head. The headset 1 may be held in place simply by the rigidity of the headband 2 and/or by a fastening mechanism not shown in FIG. 1. Attached to the headband 2 are one or more transparent or semitransparent lenses 3, which include one or more transparent or semitransparent AR/VR display devices 4, each of which can overlay images on the user's view of his environment, for one or both eyes. The details of the AR/VR display devices 4 are not germane to the technique introduced here; display devices capable of overlaying machine-generated images on a real-time, real-world view of the user's environment are known in the art, and any known or convenient mechanism with such capability can be used.

The headset 1 further includes a microphone 5 to input speech from the user (e.g., for use in recognizing voice commands); one or more audio speakers 6 to output sound to the user; one or more eye-tracking cameras 7, for use in tracking the user's head position and orientation in real-world space; one or more illumination sources 8 for use by the eye-tracking camera(s) 7; one or more depth cameras 9 for use in detecting and measuring distances to nearby surfaces; one or more outward-aimed visible spectrum cameras 10 for use in capturing standard video of the user's environment and/or in determining the user's location in the environment; and circuitry 11 to control at least some of the aforementioned elements and perform associated data processing functions. The circuitry 11 may include, for example, one or more processors and one or more memories. Note that in other embodiments the aforementioned components may be located in different locations on the headset 1. Additionally, some embodiments may omit some of the aforementioned components and/or may include additional components not mentioned above.

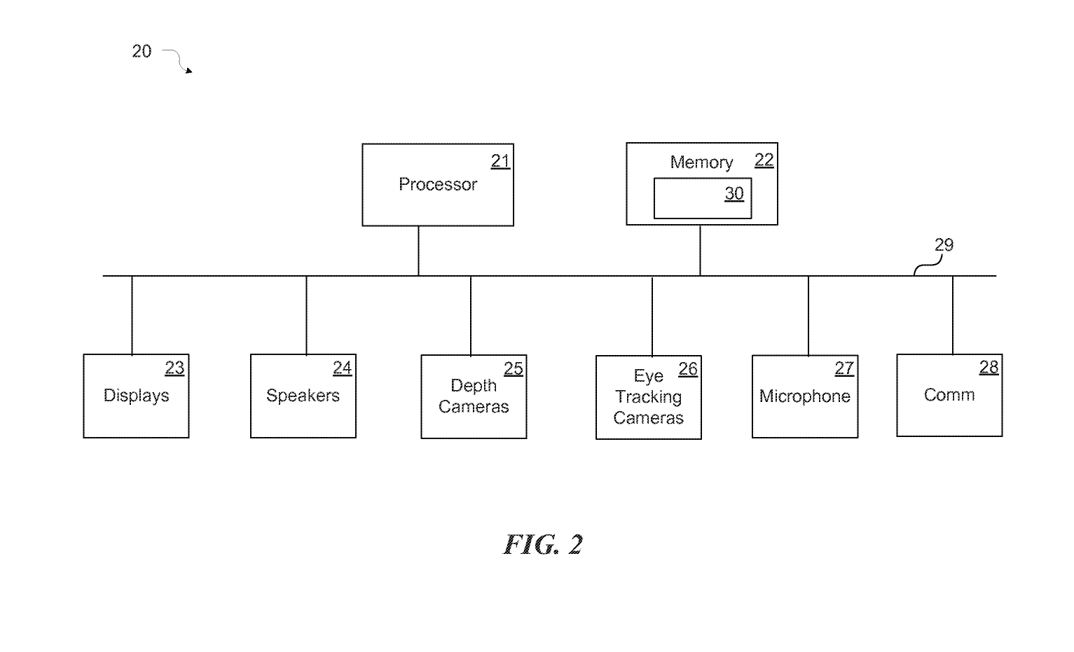

FIG. 2 is a high-level block diagram of certain components of an AR/VR headset 20, according to some embodiments of the technique introduced here. The headset 20 and components in FIG. 2 may be representative of the headset 1 in FIG. 2. In FIG. 2, the functional components of the headset 20 include one or more instance of each of the following: a processor 21, memory 22, transparent or semi-transparent AR/VR display device 23, audio speaker 24, depth camera 25, eye-tracking camera 26, microphone 27, and communication device 28, all coupled together (directly or indirectly) by an interconnect 29. The interconnect 29 may be or include one or more conductive traces, buses, point-to-point connections, controllers, adapters, wireless links and/or other conventional connection devices and/or media, at least some of which may operate independently of each other.

The processor(s) 21 individually and/or collectively control the overall operation of the headset 20 and perform various data processing functions. Additionally, the processor(s) 21 may provide at least some of the computation and data processing functionality for generating and displaying the above-mentioned virtual measurement tool. Each processor 21 can be or include, for example, one or more general-purpose programmable microprocessors, digital signal processors (DSPs), mobile application processors, microcontrollers, application specific integrated circuits (ASICs), programmable gate arrays (PGAs), or the like, or a combination of such devices.

Data and instructions (code) 30 that configure the processor(s) 31 to execute aspects of the technique introduced here can be stored in the one or more memories 22. Each memory 22 can be or include one or more physical storage devices, which may be in the form of random access memory (RAM), read-only memory (ROM) (which may be erasable and programmable), flash memory, miniature hard disk drive, or other suitable type of storage device, or a combination of such devices.

The one or more communication devices 28 enable the headset 20 to receive data and/or commands from, and send data and/or commands to, a separate, external processing system, such as a personal computer or game console. Each communication device 28 can be or include, for example, a universal serial bus (USB) adapter, Wi-Fi transceiver, Bluetooth or Bluetooth Low Energy (BLE) transceiver, Ethernet adapter, cable modem, DSL modem, cellular transceiver (e.g., 3G, LTE/4G or 5G), baseband processor, or the like, or a combination thereof.

Each depth camera 25 can apply, for example, time-of-flight principles to determine distances to nearby objects. The distance information acquired by the depth camera 25 is used (e.g., by processor(s) 21) to construct a 3D mesh model of the surfaces in the user's environment. Each eye tracking camera 26 can be, for example, a near-infrared camera that detects gaze direction based on specular reflection, from the pupil and/or corneal glints, of near infrared light emitted by one or more near-IR sources on the headset, such as illumination source 7 in FIG. 1. To enable detection of such reflections, the internal surface of the lenses of the headset (e.g., lenses 3 in FIG. 1) may be coated with a substance that is reflective to IR light but transparent to visible light; such substances are known in the art. This approach allows illumination from the IR source to bounce off the inner surface of the lens to the user's eye, where it is reflected back to the eye tracking camera (possibly via the inner surface of the lens again).

Note that any or all of the above-mentioned components may be fully self-contained in terms of their above-described functionally; however, in some embodiments, one or more processors 21 provide at least some of the processing functionality associated with the other components. For example, at least some of the data processing for depth detection associated with depth cameras 25 may be performed by processor(s) 21. Similarly, at least some of the data processing for gaze tracking associated with gaze tracking cameras 26 may be performed by processor(s) 21. Likewise, at least some of the image processing that supports AR/VR displays 23 may be performed by processor(s) 21; and so forth.

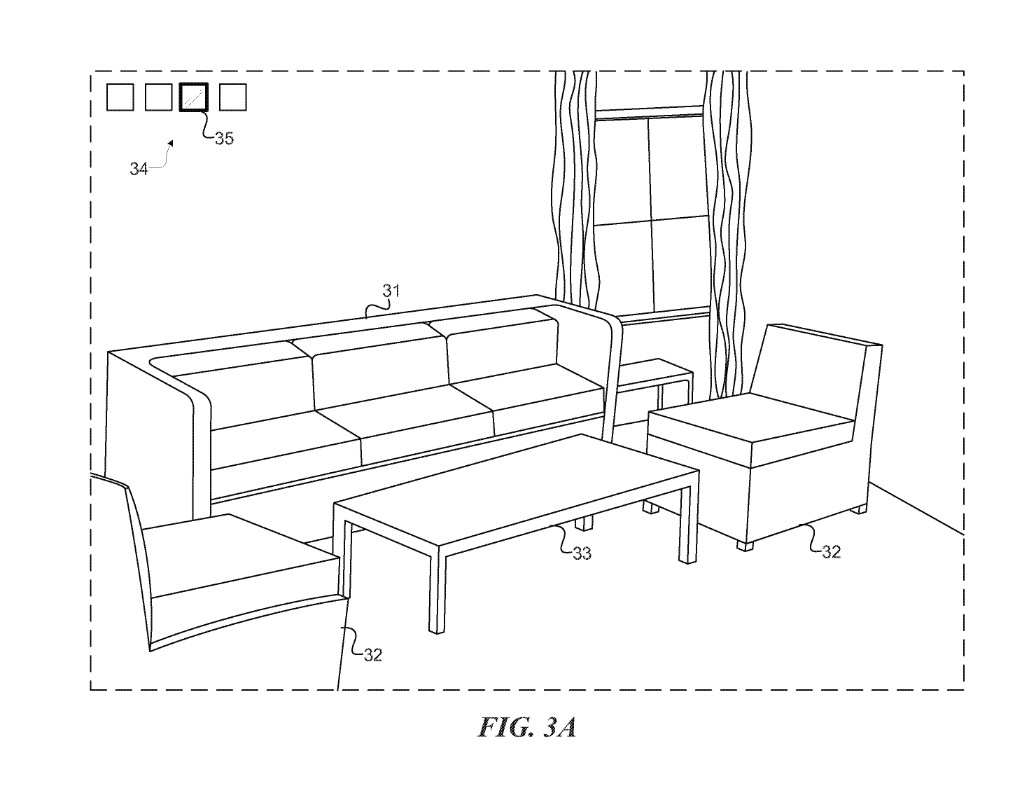

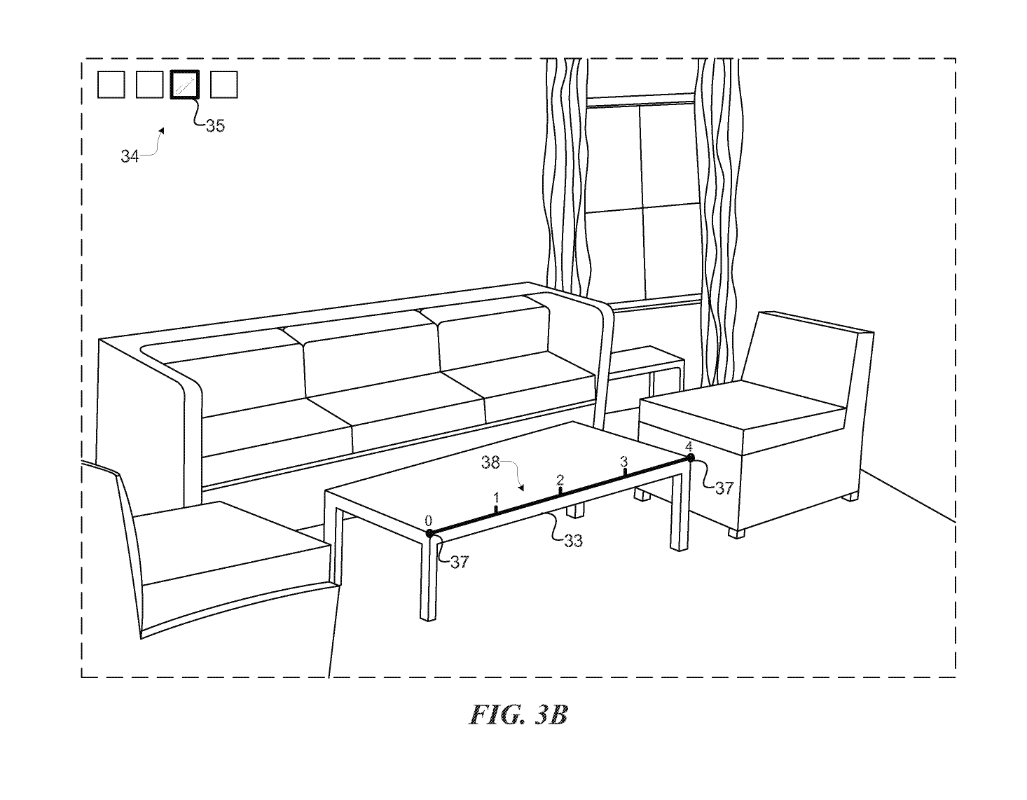

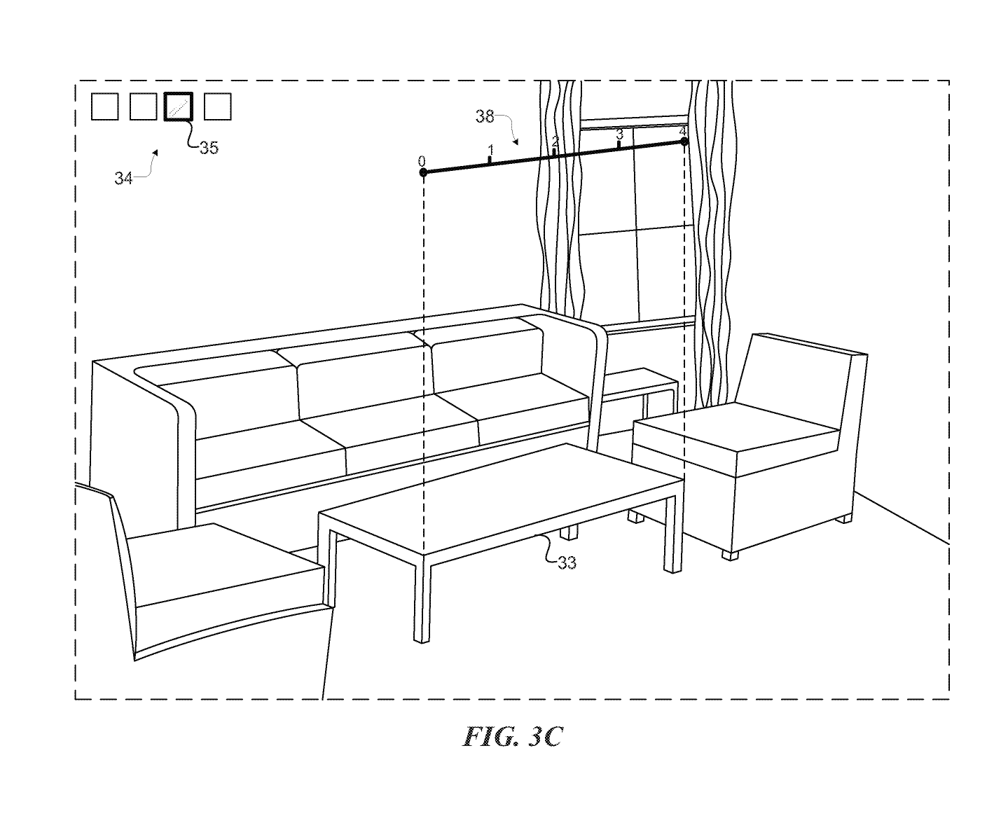

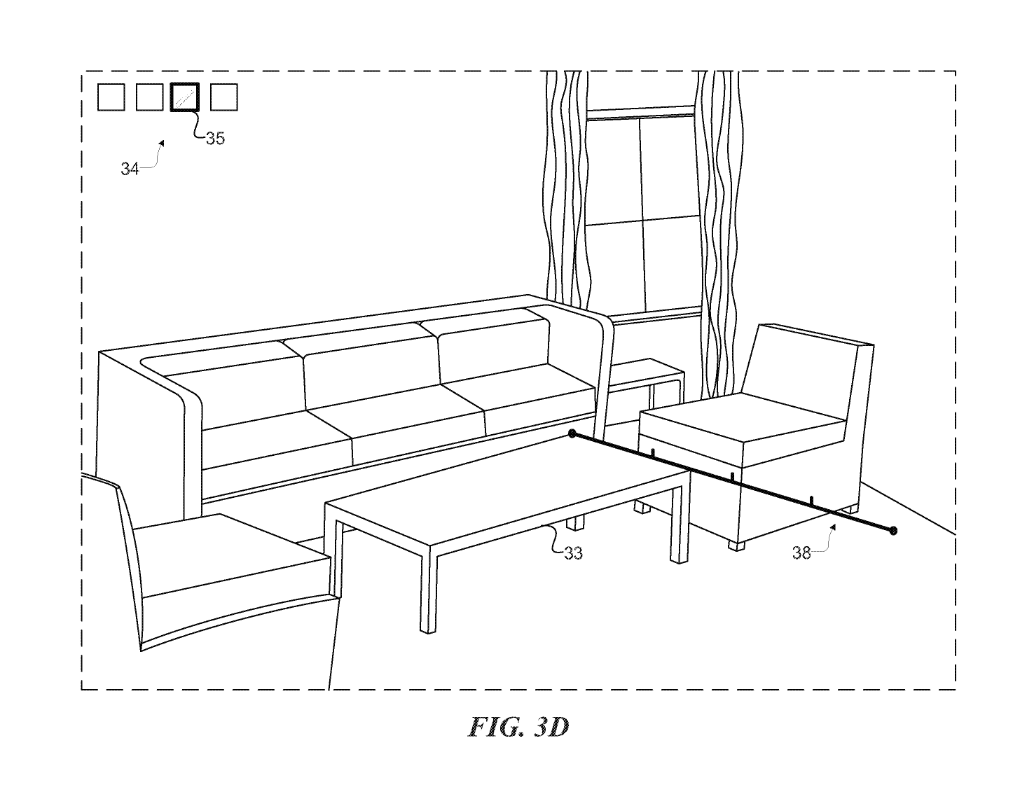

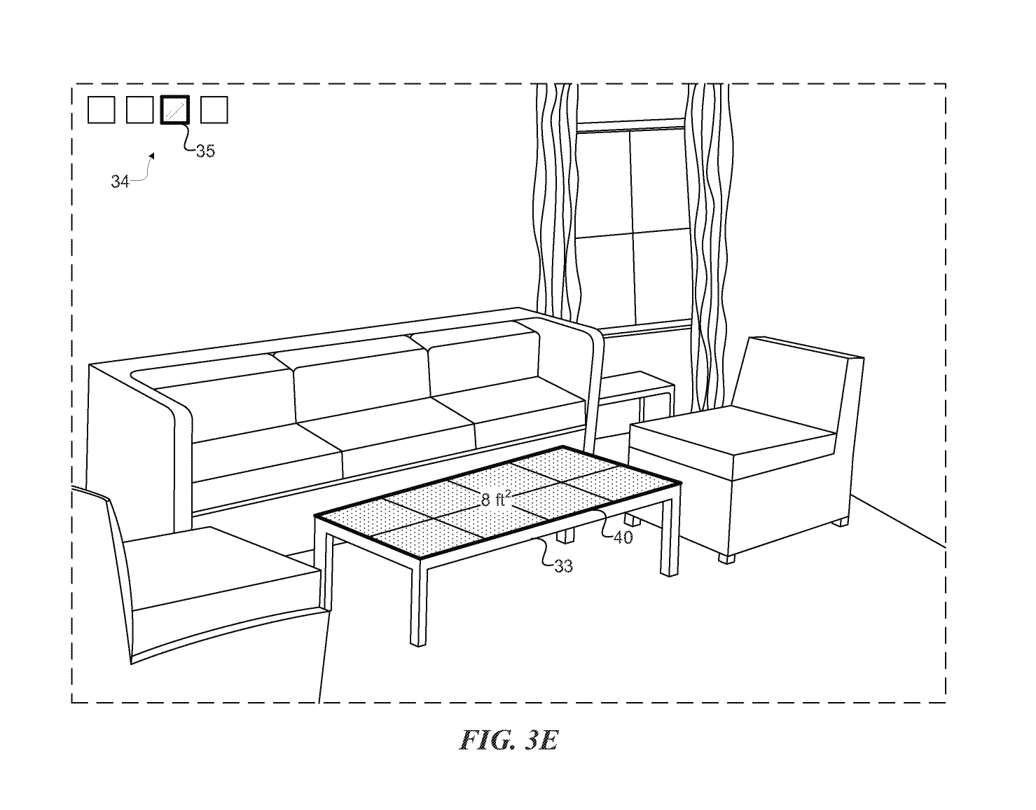

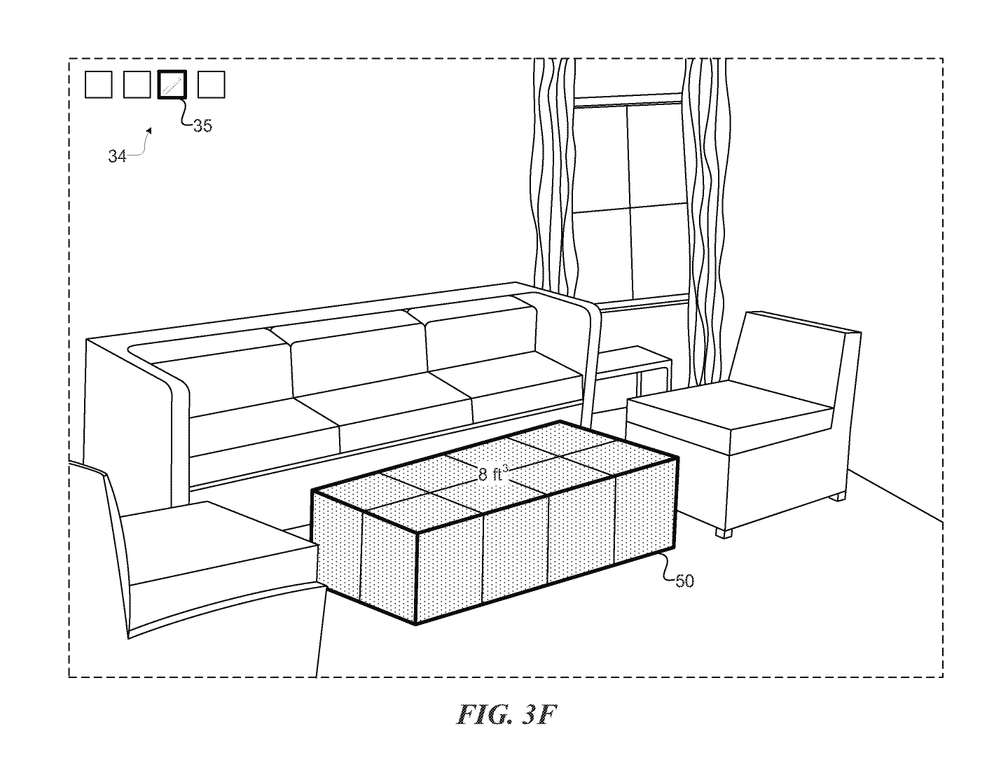

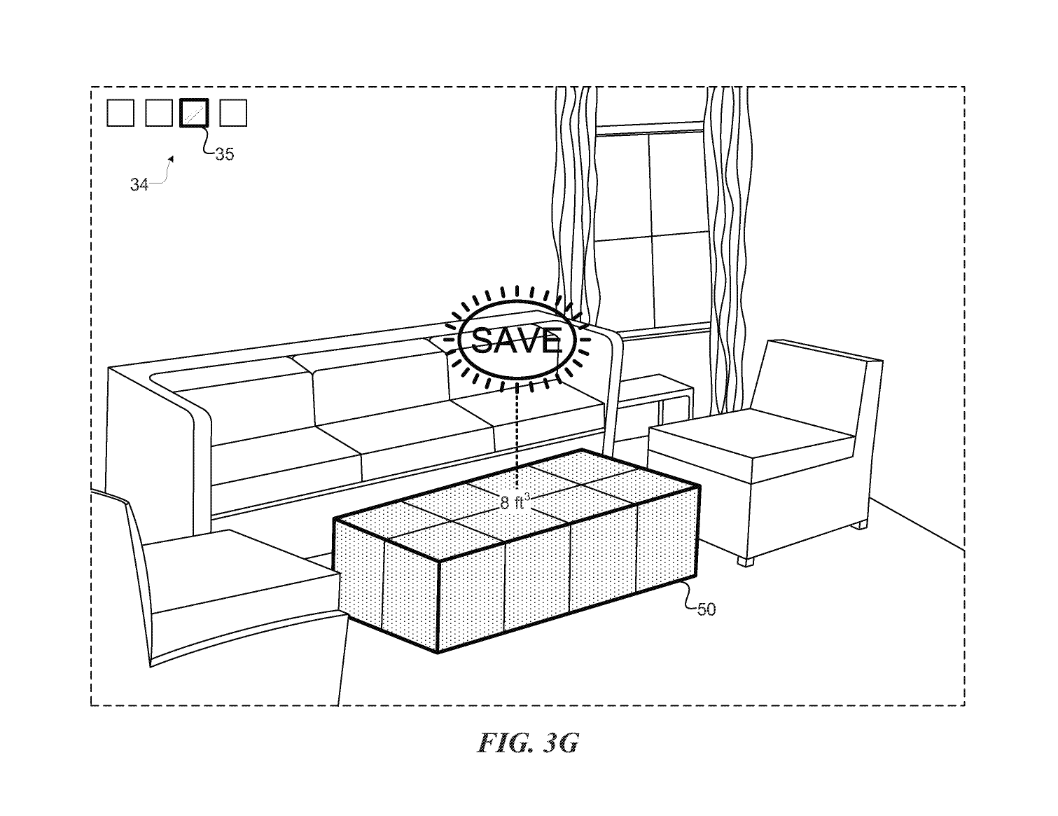

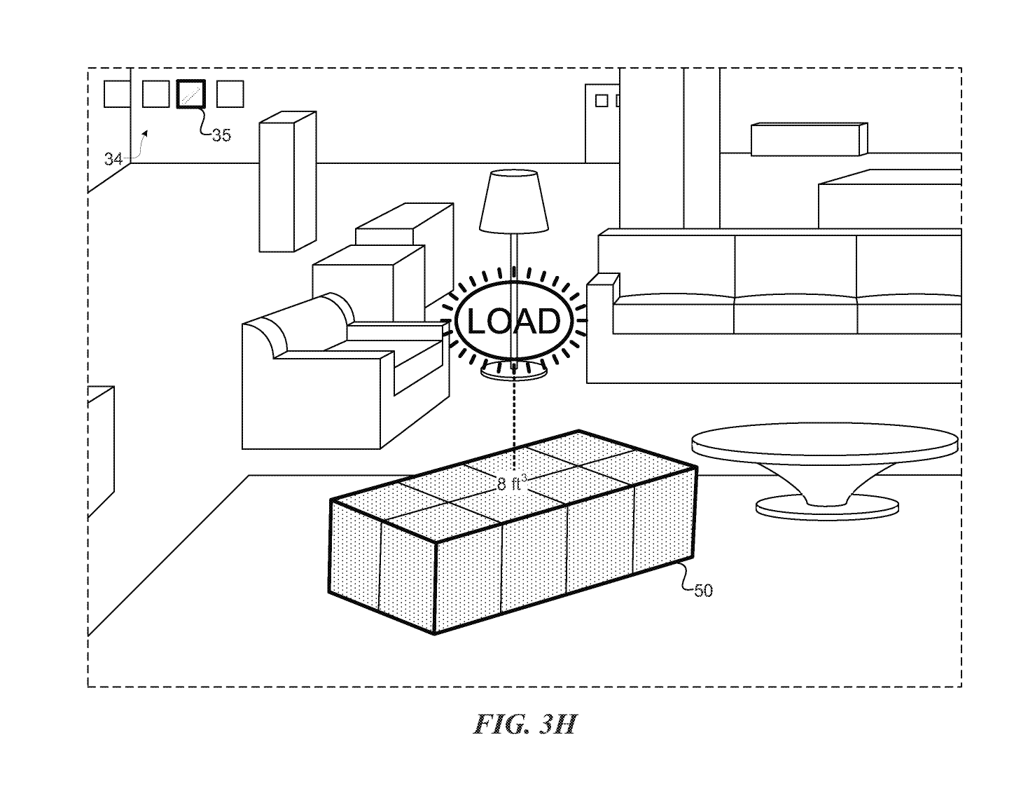

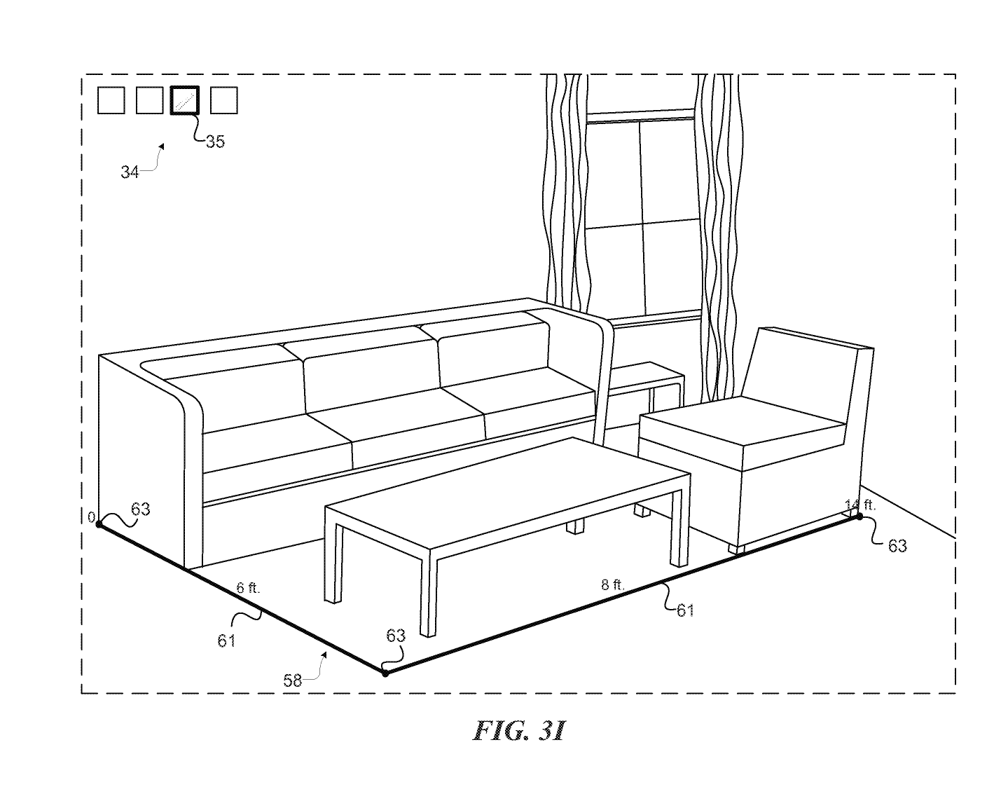

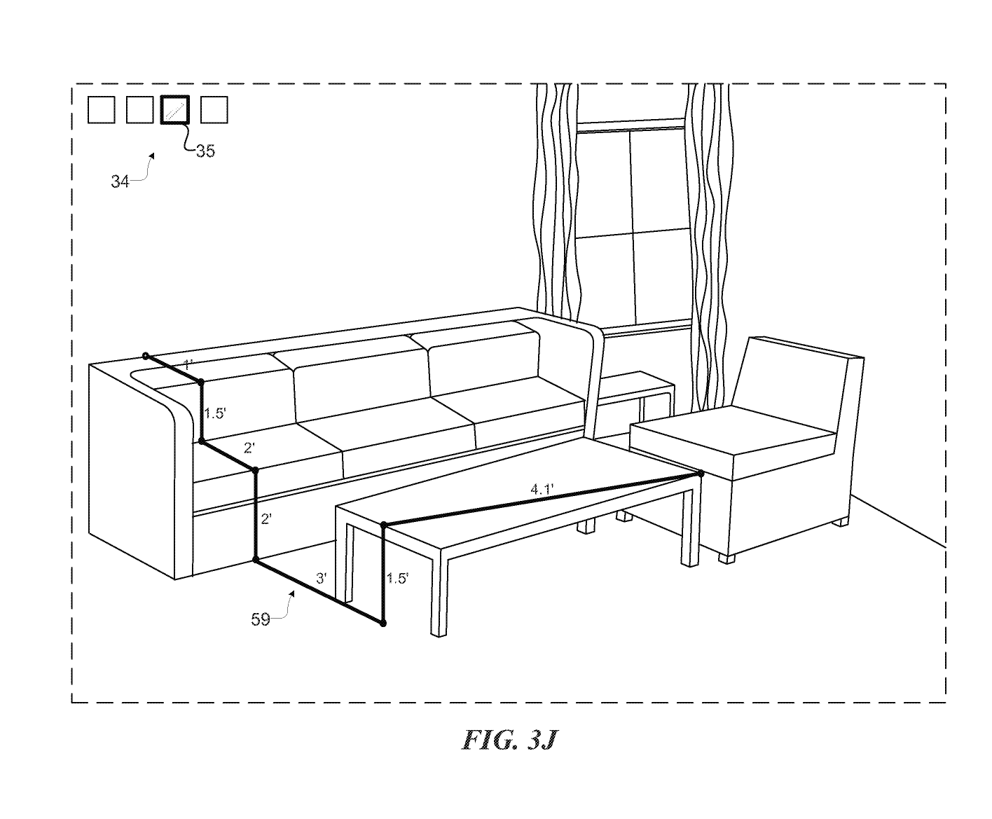

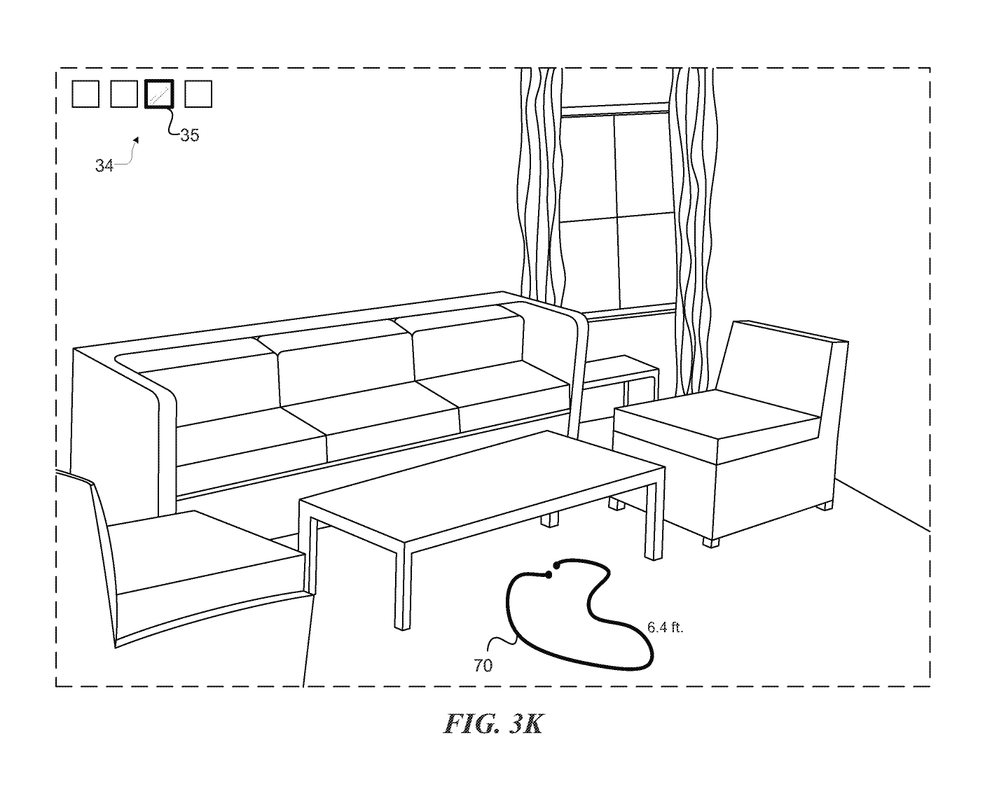

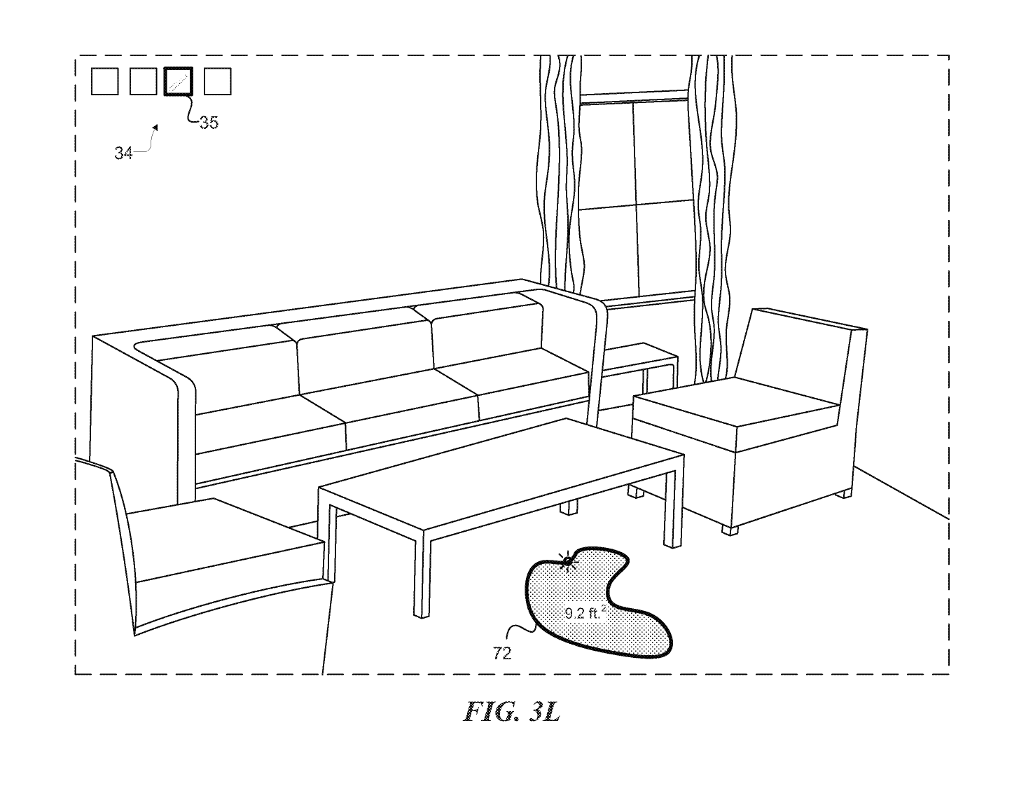

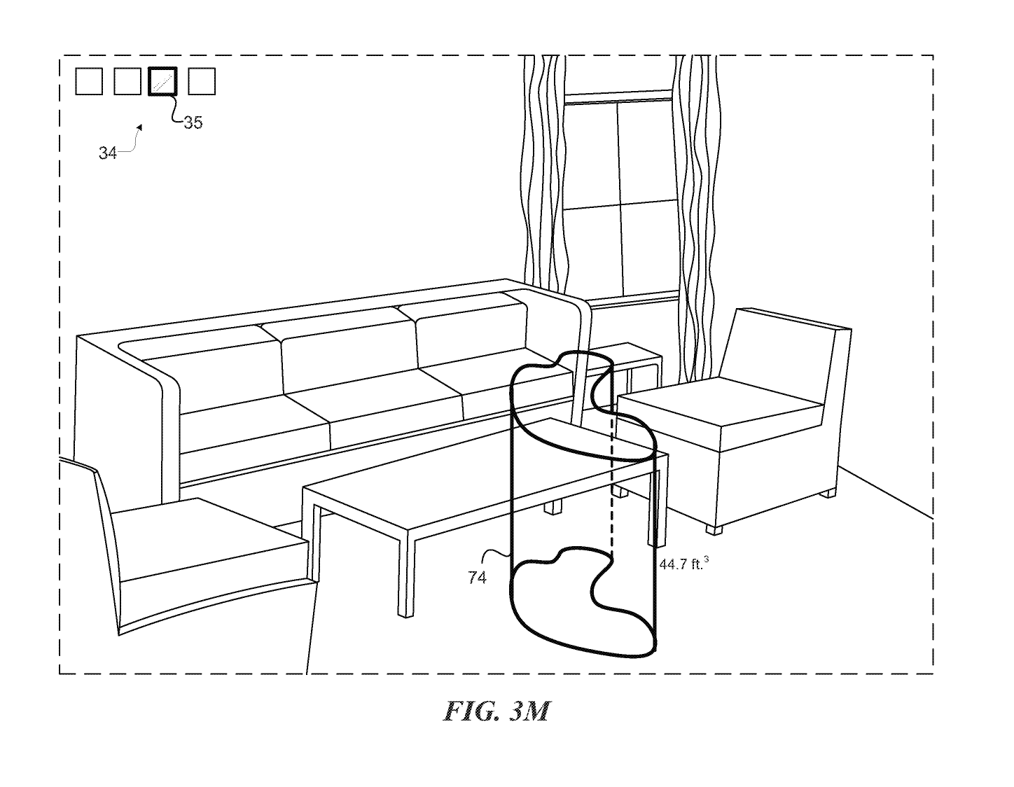

An example of how an AR/VR headset can provide the virtual measurement tool will now be described with reference to FIGS. 3A through 3H. FIGS. 3A through 3H show various examples of a user's view through an AR/VR headset (e.g., through lenses 3 and display devices 4 in FIG. 1). In particular, FIG. 3A shows the central portion of a view that a user of the headset might have while standing in a room in his home while wearing the headset (peripheral vision is truncated in the figure due to page size limitations). The user may see, for example, a sofa 31 and chairs 32, positioned around a coffee table 22. The headset may display one or more holographic icons 34 or other user interface elements in the user's field of view, to enable the user to use various functions of the headset. For example, one of the user interface elements may be an icon 35 (or other equivalent element) for selecting/initiating operation of the virtual measurement tool.

While the headset is operational, it uses its depth camera(s) to construct a 3D mesh model of all surfaces in the user's vicinity (e.g., within several meters), or at least of all nearby surfaces within the user's field of view, including their distances from the user (i.e., from the headset). Techniques for generating a 3D mesh model of nearby surfaces by using depth detection (e.g., time of flight) are known in the art and need not be described herein. Accordingly, the 3D mesh model in the example of FIG. 3A would model at least all visible surfaces of the sofa 31, chairs 32 and coffee table 33, as well as the room's walls, floor and ceiling, windows, and potentially even smaller features such as curtains, artwork (not shown) mounted on the walls, etc. The 3D mesh model can be stored in memory on the headset. By use of the 3D mesh model and image data from the visual tracking system (e.g., cameras 10), circuitry in the headset (e.g., processor(s) 21) can at any time determine the user's precise position within the room. The 3D mesh model can be automatically updated on a frequent basis, such as several times per second.

Assume now that the user wants to replace the coffee table 33 with a new one, but would like to replace it with a coffee table of similar size and keep in the same location in the room. Therefore, the user may decide to use the tool to measure the dimensions of the coffee table 33. To do so, the user first inputs a command to select or initialize the tool. This command, like all other user commands mentioned in this description unless stated otherwise, can be, for example, a hand gesture, a spoken command, or a gaze-based action of the user (e.g., the user's act of dwelling his gaze on a displayed holographic icon), or a combination of these types of input.

In this example, after the user selects the tool, the user provides input to the headset to specify two points 37, which in this example are the user's initial desired endpoints of the virtual measurement tool. In other embodiments, the tool may be initially displayed at a predetermined default location and orientation in space relative to the user. In this example scenario, the points 37 correspond to separate corners of the top surface of the coffee table 33. The user may specify each point 37 by, for example, performing a “tap” gesture with the finger directed (from the user's viewpoint) at each corner of the coffee table, or by pointing at each corner and speaking an appropriate command such as “Place point.” By correlating the user's input with the already created 3D mesh model of the room, the processor(s) in the headset can determine the most likely 3D spatial coordinates that the user intended to identify. Note, however, that a point 37 in this context does not necessarily have to coincide with a corner of a physical object. For example, the user can specify an endpoint 37 of the tool as being on any (headset-recognized) surface in the user's vicinity or even floating in the air. If the user's input appears to specify a point on a physical object, as in the present example, the processor(s) will associate the point with, and anchor the point to, that object. This process of automatically locating an endpoint on, and anchoring it to, a point on a physical object is called “snapping.” The snapping feature works similar to magnetic attraction in the real world, in that the virtual ruler 38 will appear to “stick” to the physical object until the user clearly indicates through some input (e.g., gaze, speech or gesture) the intent to unstick it.

In the present example, once the user has specified the two points 37, the headset displays a holographic (virtual) line 38, i.e., a virtual ruler, connecting the two points 37. In this example, therefore, the line 38 extends along one of the longer edges of the top surface of the coffee 33. The line 38 may be annotated with hashmarks and/or numerals indicating units, such as feet and inches, and/or fractions thereof.

When the virtual ruler 38 is anchored to an object, as in the present example, the headset by default may adjust its display so that it appears to the user to remain fixed to that object in the same orientation, even if the user moves around the room, unless the user provides input to modify that functionality. The user can choose to unanchor the virtual ruler 38 from an object and move it around in space, as shown in FIGS. 3C and 3D. In FIG. 3C, for example, the user has lifted (translated) the virtual ruler 38 vertically off the coffee table 33. In FIG. 3D, the user has rotated the virtual ruler 38 about a vertical axis. The user can move the virtual ruler 38 in translation along any of three orthogonal coordinate axes (e.g., x, y and z) and also can rotate the ruler about any of three orthogonal axes. Again this can be accomplished by any suitable command(s), such as a spoken command, a gesture, or a change in the user's gaze, or a combination thereof.

Instead of initially anchoring the virtual ruler 38 to an object, the user can instead instantiate the virtual ruler 38 so that it is initially floating in space and then (optionally) “snap” it to a physical object. The virtual ruler 28 can be snapped to any edge or surface represented in the 3D mesh of the local environment. The headset can infer the user's intent to snap based on any of various inputs, such as a spoken command, a gesture, or the user's gaze dwelling on the object, or a combination thereof. This determination/inference may also be based on how close the physical object is to the user and/or how central the object is in the user's field of view.

A virtual measurement tool such as described herein can also have the form of a (2D) polygon, by allowing the user to specify three or more related points, instead of just two endpoints. In such instances, the headset can automatically compute and display to the user the value of the area of the polygon, in addition to the length of each side of the polygon. For example, referring now to FIG. 3E, the user may want to know how much area the coffee table 33 takes up; accordingly, the user can define the tool to be in the form of a rectangle 40 corresponding to the top surface of the coffee table 33. Though not shown in FIG. 3E, the display of the polygon embodiment of the tool may also include units and values, as with the linear embodiment. The headset can also automatically compute and display that area (e.g., “8 ft²” in the present example). In some instances, the user may initially specify all of the three or more points when defining the initial endpoints as described above (FIG. 3B); alternatively, the user may initially define the tool as just a line between two points (as described above) and then subsequently add one or more additional points to expand the tool into a polygon, or a 3D volume. The headset can use any of various techniques to infer the user's intent in this regard. For example, if the user initially specifies three or more points relatively close together in time, or all on the same physical object, it may infer that the user wishes to define the tool as a polygon. If the user initially defines the tool as a line, the user may subsequently add one or more points to convert it into a polygon, for example by a command (e.g., saying “Add point”), or the headset may infer the user's intent to add a point based on the user's behavior. As in the example of the linear measurement tool (e.g., virtual ruler 38), the user can move the polygon-shaped tool in translation and rotation.

In a similar manner, the tool can also have the form of a 3D object, by allowing the user to specify four or more related points. In such instances, the headset can automatically compute and display to the user the value of the volume of the tool, as well as the area of any surface and length of each side of the object. For example, referring now to FIG. 3F, the user can define the tool as a rectangular box 50 representing the outer spatial “envelope” of the coffee table. Though not shown in FIG. 3E, the display of the polygon embodiment of the tool may also include units and values, as with the linear embodiment. The headset can also automatically compute and display the volume of the tool (box 50), as shown (e.g., “8 ft³” in the present example). As in the examples of the linear and 2D virtual measurement tools, the user can also move the 3D tool in translation and rotation.

In some instances, the headset allows the user to save the current state of the tool in memory, including any corresponding measurement values and settings, and reload/redisplay it at a different location. For example, in the present example, the user may wish to save the tool in its present form, and redisplay it at another location, such as at a furniture store. Therefore, as illustrated in FIG. 3G, the user can input an appropriate command (e.g., by saying “Save” or making an appropriate hand gesture to select a corresponding displayed icon 34). Later, when the user visits a furniture store, as illustrated in FIG. 3H, the user can cause the headset to load the tool from memory and redisplay it, by an appropriate command (e.g., by saying “Load” or making an appropriate hand gesture to select a corresponding displayed icon 34). The user can adjust the position and orientation of the tool to conform to that of a physical object in the store (e.g., a new coffee table), to enable the user to measure that object.

Various other usage scenarios for the virtual measurement tool are contemplated. For example, the headset may enable the user to specify three or more endpoints in a sequence and may automatically compute and display the sum of the lengths of the segments defined by those three or more endpoints. An example of this usage scenario is shown in FIG. 3I, in which the virtual ruler 58 is made of two connected linear segments 61, defined by three endpoints 63, where the length of each segment and the sum of the lengths of the two segments are shown. Furthermore, as illustrated in FIG. 3J, by using the headset's surface recognition capability the user can “wrap” a virtual ruler 59 around one or more surfaces by generating multiple endpoints over time (or based on a distance threshold), where the headset can automatically compute and display the length of each segment and the sum of the lengths of the segments.

Additionally, the virtual measurement tool does not have to be instantiated as straight lines. For example, as illustrated in FIG. 3K, the user can define a virtual ruler 70 as a curved/irregular line (e.g., by using a hand gesture), where the headset can still compute the overall length of the virtual ruler (e.g., by dividing it into one or more radii about one or more corresponding center points and then computing the length of each radius). Regardless of whether the tool is in the form of linear or curved/irregular segments (or a combination thereof), the user can “snap” its endpoints together to form an enclosed 2D shape, such as shape 72 in FIG. 3L. In that case the headset can automatically compute and display the area enclosed by the newly defined shape. Further, as shown in FIG. 3M, the user can create a 3D shape (such as volume 74) from any 2D shape, by inputting an appropriate command, in which case the headset also can automatically compute and display the total volume enclosed by the 3D shape.

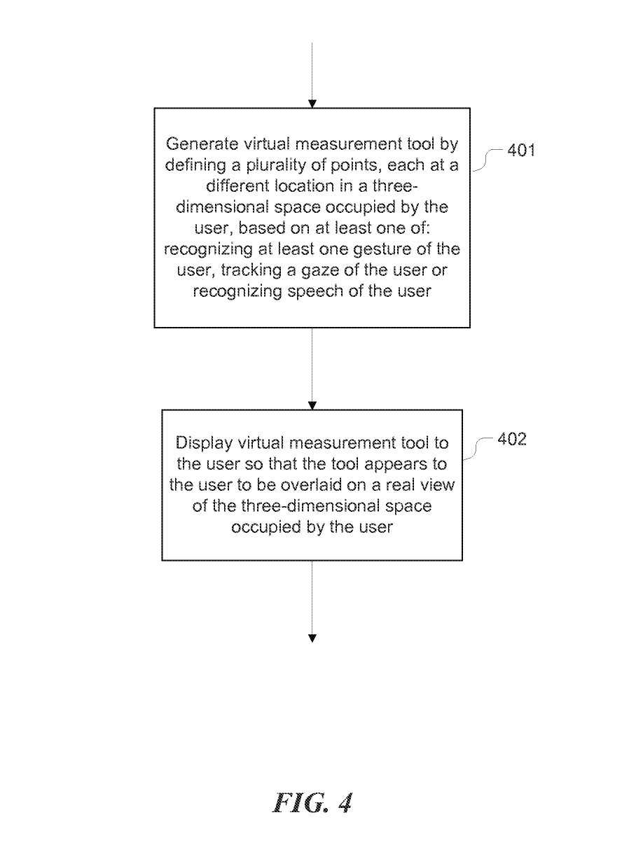

FIG. 4 illustrates an example of a process that can be performed by the headset (e.g., by processor(s) 21) for providing the virtual measurement tool, according to some embodiments. Initially, at step 401 the headset generates the virtual measurement tool by defining a plurality of points, each at a different location in a 3D space occupied by the user, based on input from the user, such as by using gesture recognition, gaze tracking and/or speech recognition. Then, at step 402, the headset displays the virtual measurement tool to the user so that the tool appears to the user to be overlaid on a real-time, real-world view of the 3D space occupied by the user.

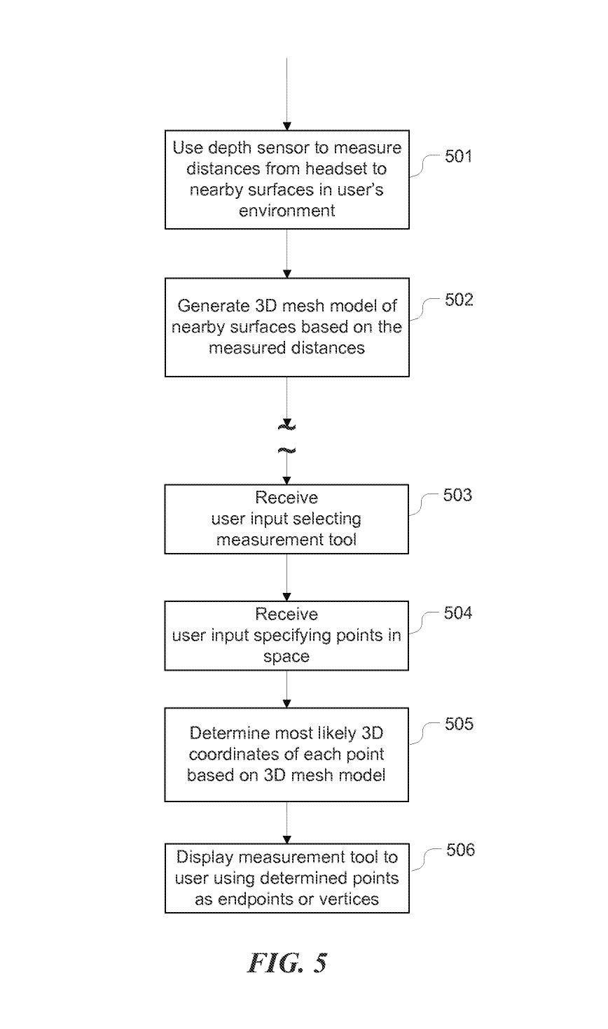

FIG. 5 illustrates an example of the process of providing the virtual measurement tool in greater detail, according to some embodiments. When the headset is first powered up and initialized, the headset at step 501 uses its depth sensor to measure distances from the headset to nearby surfaces in the user's environment. The headset then generates a 3D mesh model of those surfaces based on the measured distances at step 502. Any known or convenient technique for generating a 3D mesh model surfaces can be used in this step. At some later time, and not necessarily as a consequence of step 502, the headset receives user input selecting the virtual measurement tool at step 503. The headset then at step 504 receives user input (e.g., one or more gestures, spoken commands and/or gaze-based commands) for specifying two or more points in space in the user's environment. At step 505 the headset determines the user-specified points by determining the most likely 3D coordinates of each user-specified point, based (at least in part) on a 3D mesh model. At step 506, the headset displays measurement tool to the user using the determined points as endpoints or vertices of the tool.

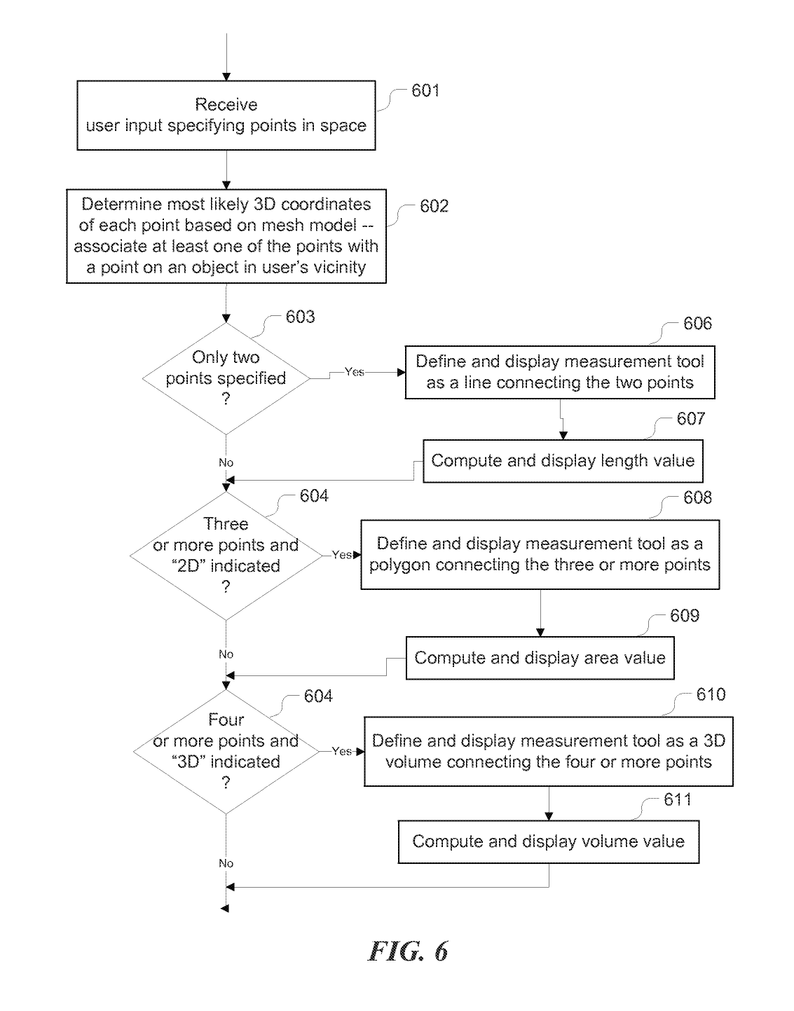

FIG. 6 illustrates a process of generating and displaying the tool in greater detail, according to an example scenario. At step 601, headset receives user input (e.g., one or more gestures, spoken commands and/or gaze-based commands) specifying two or more points in space. At step 602 the headset determines the most likely 3D coordinates of each point, based on the 3D mesh model. In this example, this step further includes associating at least one of the points with a point on an object in the user's vicinity, which further may include anchoring the point of the object. Consequently, if the user moves through the environment, the point (which defines an endpoint or vertex of the tool) will remain fixed to the object from the user's perspective.

In the illustrated example scenario, if the user has specified only two points (step 603), then the headset defines and displays the measurement tool as a line connecting those two points at step 606 (and optionally, with indications of units and values). The headset also computes and displays the length of that line to the user. The process then proceeds to step 604. At step 604, if the user has specified three or more points and has indicated (either expressly or implicitly) a desire to perform a 2D measurement (e.g., of area), the headset at step 608 defines and displays the measurement tool as a polygon connecting the three or more points. The headset also computes and displays the area of the polygon at step 609, and then proceeds to step 604. In step 604, if the user has specified four or more points and has indicated (either expressly or implicitly) a desire to perform a 3D measurement (e.g., of volume), the headset at step 610 defines and displays the measurement tool as a 3D volume connecting the four or more points. The headset also computes and displays the volume enclosed by the tool at step 611.

In a variation of the technique described above, the virtual measurement tool can be instantiated and/or used by multiple users cooperating in a shared AR environment. For example, two or more users, each using a visualization device such as described above, can measure a shared physical space together and can each establish points in the real world that contribute to the overall measurement and markup of the space. In such an embodiment, the two or more visualization devices may communicate with each other, either directly or through a separate processing device (e.g., computer); or, the visualization devices may communicate separately with such a separate processing device, which coordinates measurement and display functions of all of the visualization devices.

Hence, a virtual (holographic) measurement tool for use in a wearable AR/VR display system has been described.

The machine-implemented operations described above can be implemented by programmable circuitry programmed/configured by software, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), system-on-a-chip systems (SOCs), etc.

Software to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

### Examples of Certain Embodiments

Certain embodiments of the technology introduced herein are summarized in the following numbered examples:

1. A method comprising: generating a virtual measurement tool, by a visualization device worn by a user, by determining a plurality of points, each at a different location in a three-dimensional space occupied by the user, based on at least one of: recognizing at least one gesture of the user, tracking a gaze of the user or recognizing speech of the user; and displaying the virtual measurement tool to the user, by the visualization device, so that the virtual measurement tool appears to the user to be overlaid on a real view of the three-dimensional space occupied by the user.

2. A method as recited in example 1, wherein generating the virtual measurement tool comprises anchoring the plurality of points to respective different points in the three-dimensional space, so that the virtual measurement tool appears to the user to remain at a fixed location and orientation in space as the user moves through the three-dimensional space.

3. A method as recited in example 1 or example 2, wherein generating the virtual measurement tool comprises spatially associating at least one of the plurality of points with a corresponding point on a physical object in the three-dimensional space occupied by the user.

4. A method as recited in any of examples 1 through 3, wherein generating the virtual measurement tool comprises generating at least a portion of the virtual measurement tool as a line between two of the plurality of points.

5. A method as recited in any of examples 1 through 4, wherein generating the virtual measurement tool comprises generating the virtual measurement tool as a polygon that has vertices at three or more of the plurality of points.

6. A method as recited in any of examples 1 through 5, wherein generating the virtual measurement tool comprises generating the virtual measurement tool as a three-dimensional volume that has vertices at four or more of the plurality of points.

7. A method as recited in any of examples 1 through 6, wherein displaying the virtual measurement tool comprises displaying a measurement scale on or in proximity to the virtual measurement tool.

8. A method as recited in any of examples 1 through 7, further comprising: computing, by the visualization device, a length, area or volume, based on the plurality of points; and outputting the length, area or volume, by the visualization device, to the user.

9. A method as recited in any of examples 1 through 8, wherein the three-dimensional space occupied by the user is a first three-dimensional space, the method further comprising: saving the virtual measurement tool to a memory in response to a first user command; discontinuing display of the virtual measurement tool by the visualization device; and in response to a second user command after the user has relocated to a second three-dimensional space, retrieving the virtual measurement tool from the memory and redisplaying the virtual measurement tool to the user while the user occupies the second three-dimensional space, wherein the redisplaying includes spatially associating the virtual measurement tool with an object in the second three-dimensional space.

10. A method as recited in any of examples 1 through 9, further comprising using a depth sensor to measure distances from the visualization device to objects in the three-dimensional space occupied by the user; and generating a 3D mesh model of surfaces in the three-dimensional space occupied by the user, based on the measured distances; and using the 3D mesh model to determine spatial coordinates of the plurality of points, based on the at least one user input, wherein using the 3D mesh model to determine spatial coordinates of the plurality of points includes determining a location of at least one of the plurality of points to be spatially associated with one of said objects.

11. A method as recited in any of examples 1 through 10, further comprising: determining an adjustment to a location or orientation of the virtual measuring tool by at least one of: recognizing a gesture of the user, tracking a gaze of the user or recognizing speech of the user; and adjusting the location or orientation of the virtual linear measuring tool as displayed to the user, based on the adjustment.

12. A method comprising: using a depth sensor on a head-mounted visualization device to measure distances from the visualization device to objects in a first enclosed space occupied by a user of the visualization device; generating a 3D mesh model of surfaces in the first enclosed space, based on the measured distances; generating a virtual measurement tool, by the visualization device, by determining a plurality of points, each at a different location in the first enclosed space, according to at least one input from the user, including determining a location of at least one of the plurality of points to be spatially associated with one of said objects, said at least one input including at least one of: a gesture of the user, a gaze direction of the user or speech of the user; and displaying the virtual measurement tool to the user, by the visualization device, so that the virtual measurement tool appears to the user to be overlaid on a real view of the first enclosed space, wherein said displaying includes displaying a measurement scale on or in proximity to the virtual measurement tool, wherein generating the virtual measurement tool includes anchoring the plurality of points to respective different points in the first enclosed space, so that the virtual measurement tool appears to the user to remain at a fixed location and orientation in space as the user moves through the first enclosed space; determining an adjustment to a location or orientation of the virtual measuring tool by at least one of: recognizing a gesture of the user, tracking a gaze of the user or recognizing speech of the user; and adjusting the location or orientation of the virtual linear measuring tool as displayed to the user, based on the adjustment.

13. A method as recited in example 12, wherein generating the virtual measurement tool comprises generating at least a portion of the virtual measurement tool as a line between two of the plurality of points.

14. A method as recited in example 12 or example 13, wherein generating the virtual measurement tool comprises at least one of: generating at least a portion of the virtual measurement tool as a polygon that has vertices at three or more of the plurality of points; or generating at least a portion of the virtual measurement tool as a three-dimensional volume that has vertices at four or more of the plurality of points.

15. A method as recited in any of examples 12 through 14, further comprising: computing, by the visualization device, a length, area or volume, based on the plurality of points; and outputting the length, area or volume, by the visualization device, to the user.

16. A head-mounted visualization device comprising: a head fitting by which to mount the head-mounted visualization device to the head of a user; an at least partially transparent display surface, coupled to the head fitting, on which to display generated images to the user; an input subsystem to receive inputs from the user and configured to perform gesture recognition and gaze detection; a depth sensor to determine locations of objects in an environment of the user; and a processor coupled to the display surface, the input subsystem and the depth sensor, and configured to: generate a virtual measurement tool, by determining a plurality of points, each at a different location in the environment of the user, according to at least one input from the user received via the input subsystem, wherein the location of at least one of the plurality of points is determined to be spatially associated with one of the objects in the environment of the user; and cause the display surface to display the virtual measurement tool to the user with an indication of distance, area or volume, wherein the virtual measurement tool appears to the user to remain at a fixed location and orientation in space as the user moves through the environment.

17. A head-mounted visualization device as recited in example 16, wherein the processor is further configured to determine an adjustment to a location or orientation of the virtual measuring tool based on at least one of a gesture of the user or a gaze of the user, and to adjust the location or orientation of the virtual linear measuring tool as displayed to the user, based on the adjustment.

18. A head-mounted visualization device as recited in example 16 or example 17, wherein the processor is configured to generate the virtual measurement tool as a polygon that has vertices at three or more of the plurality of points.

19. A head-mounted visualization device as recited in any of examples 16 through 18, wherein the processor is configured to generate the virtual measurement tool as a three-dimensional volume that has vertices at four or more of the plurality of points.

20. A head-mounted visualization device as recited in any of examples 16 through 19, further comprising a memory, and wherein the processor is further configured to: save the virtual measurement tool to the memory in response to a first user input; discontinue display of the virtual measurement tool by the display surface; and in response to a second user input after the user has relocated to a second environment, retrieve the virtual measurement tool from the memory and cause the display surface to redisplay the virtual measurement tool to the user while the user occupies the second environment, including spatially associating the virtual measurement tool with an object in the second environment.

21. An apparatus comprising: means for generating a virtual measurement tool, by determining a plurality of points, each at a different location in a three-dimensional space occupied by the user, based on at least one of: recognizing at least one gesture of the user, tracking a gaze of the user or recognizing speech of the user; and means for displaying the virtual measurement tool to the user, so that the virtual measurement tool appears to the user to be overlaid on a real view of the three-dimensional space occupied by the user.

22. An apparatus as recited in example 21, wherein the means for generating the virtual measurement tool comprises means for anchoring the plurality of points to respective different points in the three-dimensional space, so that the virtual measurement tool appears to the user to remain at a fixed location and orientation in space as the user moves through the three-dimensional space.

23. An apparatus as recited in example 21 or example 22, wherein the means for generating the virtual measurement tool comprises means for spatially associating at least one of the plurality of points with a corresponding point on a physical object in the three-dimensional space occupied by the user.

24. An apparatus as recited in any of examples 21 through 23, wherein the means for generating the virtual measurement tool comprises means for generating at least a portion of the virtual measurement tool as a line between two of the plurality of points.

25. An apparatus as recited in any of examples 21 through 24, wherein the means for generating the virtual measurement tool comprises means for generating the virtual measurement tool as a polygon that has vertices at three or more of the plurality of points.

26. An apparatus as recited in any of examples 21 through 25, wherein the means for generating the virtual measurement tool comprises means for generating the virtual measurement tool as a three-dimensional volume that has vertices at four or more of the plurality of points.

27. An apparatus as recited in any of examples 21 through 26, wherein the means for displaying the virtual measurement tool comprises means for displaying a measurement scale on or in proximity to the virtual measurement tool.

28. An apparatus as recited in any of examples 21 through 27, further comprising: means for computing a length, area or volume, based on the plurality of points; and means for outputting the length, area or volume to the user.

29. An apparatus as recited in any of examples 21 through 28, wherein the three-dimensional space occupied by the user is a first three-dimensional space, the apparatus further comprising: means for saving the virtual measurement tool to a memory in response to a first user command; means for discontinuing display of the virtual measurement tool; and means for, in response to a second user command after the user has relocated to a second three-dimensional space, retrieving the virtual measurement tool from the memory and redisplaying the virtual measurement tool to the user while the user occupies the second three-dimensional space, wherein the redisplaying includes spatially associating the virtual measurement tool with an object in the second three-dimensional space.

30. An apparatus as recited in any of examples 21 through 29, further comprising means for using a depth sensor to measure distances from the visualization device to objects in the three-dimensional space occupied by the user; and means for generating a 3D mesh model of surfaces in the three-dimensional space occupied by the user, based on the measured distances; and means for using the 3D mesh model to determine spatial coordinates of the plurality of points, based on the at least one user input, wherein the means for using the 3D mesh model to determine spatial coordinates of the plurality of points includes means for determining a location of at least one of the plurality of points to be spatially associated with one of said objects.

31. An apparatus as recited in any of examples 21 through 30, further comprising: means for determining an adjustment to a location or orientation of the virtual measuring tool by at least one of: recognizing a gesture of the user, tracking a gaze of the user or recognizing speech of the user; and means for adjusting the location or orientation of the virtual linear measuring tool as displayed to the user, based on the adjustment.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
generating a virtual measurement tool, by a visualization device worn by a user, by determining a plurality of points, each at a different location in a three-dimensional space occupied by the user, based on at least one of: recognizing at least one gesture of the user, tracking a gaze of the user or recognizing speech of the user; and
displaying the virtual measurement tool to the user, by the visualization device, so that the virtual measurement tool appears to the user to be overlaid on a real view of the three-dimensional space occupied by the user.

2. A method as recited in claim 1, wherein generating the virtual measurement tool comprises anchoring the plurality of points to respective different points in the three-dimensional space, so that the virtual measurement tool appears to the user to remain at a fixed location and orientation in space as the user moves through the three-dimensional space.

3. A method as recited in claim 1, wherein generating the virtual measurement tool comprises spatially associating at least one of the plurality of points with a corresponding point on a physical object in the three-dimensional space occupied by the user.

4. A method as recited in claim 1, wherein generating the virtual measurement tool comprises generating at least a portion of the virtual measurement tool as a line between two of the plurality of points.

5. A method as recited in claim 1, wherein generating the virtual measurement tool comprises generating the virtual measurement tool as a polygon that has vertices at three or more of the plurality of points.

6. A method as recited in claim 1, wherein generating the virtual measurement tool comprises generating the virtual measurement tool as a three-dimensional volume that has vertices at four or more of the plurality of points.

7. A method as recited in claim 1, wherein displaying the virtual measurement tool comprises displaying a measurement scale on or in proximity to the virtual measurement tool.

8. A method as recited in claim 1, further comprising:
computing, by the visualization device, a length, area or volume, based on the plurality of points; and
outputting the length, area or volume, by the visualization device, to the user.

9. A method as recited in claim 1, wherein the three-dimensional space occupied by the user is a first three-dimensional space, the method further comprising:
saving the virtual measurement tool to a memory in response to a first user command;
discontinuing display of the virtual measurement tool by the visualization device; and
in response to a second user command after the user has relocated to a second three-dimensional space, retrieving the virtual measurement tool from the memory and redisplaying the virtual measurement tool to the user while the user occupies the second three-dimensional space, wherein the redisplaying includes spatially associating the virtual measurement tool with an object in the second three-dimensional space.

10. A method as recited in claim 1, further comprising:
using a depth sensor to measure distances from the visualization device to objects in the three-dimensional space occupied by the user; and
generating a 3D mesh model of surfaces in the three-dimensional space occupied by the user, based on the measured distances; and
using the 3D mesh model to determine spatial coordinates of the plurality of points, based on the at least one user input, wherein using the 3D mesh model to determine spatial coordinates of the plurality of points includes determining a location of at least one of the plurality of points to be spatially associated with one of said objects.

11. A method as recited in claim 1, further comprising:
determining an adjustment to a location or orientation of the virtual measuring tool by at least one of: recognizing a gesture of the user, tracking a gaze of the user or recognizing speech of the user; and
adjusting the location or orientation of the virtual linear measuring tool as displayed to the user, based on the adjustment.

12. A method comprising:
using a depth sensor on a head-mounted visualization device to measure distances from the visualization device to objects in a first enclosed space occupied by a user of the visualization device;
generating a 3D mesh model of surfaces in the first enclosed space, based on the measured distances;
generating a virtual measurement tool, by the visualization device, by determining a plurality of points, each at a different location in the first enclosed space, according to at least one input from the user, including determining a location of at least one of the plurality of points to be spatially associated with one of said objects, said at least one input including at least one of: a gesture of the user, a gaze direction of the user or speech of the user; and
displaying the virtual measurement tool to the user, by the visualization device, so that the virtual measurement tool appears to the user to be overlaid on a real view of the first enclosed space, wherein said displaying includes displaying a measurement scale on or in proximity to the virtual measurement tool, wherein generating the virtual measurement tool includes anchoring the plurality of points to respective different points in the first enclosed space, so that the virtual measurement tool appears to the user to remain at a fixed location and orientation in space as the user moves through the first enclosed space;
determining an adjustment to a location or orientation of the virtual measuring tool by at least one of: recognizing a gesture of the user, tracking a gaze of the user or recognizing speech of the user; and
adjusting the location or orientation of the virtual linear measuring tool as displayed to the user, based on the adjustment.

13. A method as recited in claim 12, wherein generating the virtual measurement tool comprises generating at least a portion of the virtual measurement tool as a line between two of the plurality of points.

14. A method as recited in claim 12, wherein generating the virtual measurement tool comprises at least one of:
generating at least a portion of the virtual measurement tool as a polygon that has vertices at three or more of the plurality of points; or
generating at least a portion of the virtual measurement tool as a three-dimensional volume that has vertices at four or more of the plurality of points.

15. A method as recited in claim 12, further comprising:
computing, by the visualization device, a length, area or volume, based on the plurality of points; and
outputting the length, area or volume, by the visualization device, to the user.

16. A head-mounted visualization device comprising:
a head fitting by which to mount the head-mounted visualization device to the head of a user;
an at least partially transparent display surface, coupled to the head fitting, on which to display generated images to the user;
an input subsystem to receive inputs from the user and configured to perform gesture recognition and gaze detection;
a depth sensor to determine locations of objects in an environment of the user; and
a processor coupled to the display surface, the input subsystem and the depth sensor, and configured to:
generate a virtual measurement tool, by determining a plurality of points, each at a different location in the environment of the user, according to at least one input from the user received via the input subsystem, wherein the location of at least one of the plurality of points is determined to be spatially associated with one of the objects in the environment of the user; and
cause the display surface to display the virtual measurement tool to the user with an indication of distance, area or volume, wherein the virtual measurement tool appears to the user to remain at a fixed location and orientation in space as the user moves through the environment.

17. A head-mounted visualization device as recited in claim 16, wherein the processor is further configured to determine an adjustment to a location or orientation of the virtual measuring tool based on at least one of a gesture of the user or a gaze of the user, and to adjust the location or orientation of the virtual linear measuring tool as displayed to the user, based on the adjustment.

18. A head-mounted visualization device as recited in claim 16, wherein the processor is configured to generate the virtual measurement tool as a polygon that has vertices at three or more of the plurality of points.

19. A head-mounted visualization device as recited in claim 16, wherein the processor is configured to generate the virtual measurement tool as a three-dimensional volume that has vertices at four or more of the plurality of points.

20. A head-mounted visualization device as recited in claim 16, further comprising a memory, and wherein the processor is further configured to:
save the virtual measurement tool to the memory in response to a first user input;
discontinue display of the virtual measurement tool by the display surface; and
in response to a second user input after the user has relocated to a second environment, retrieve the virtual measurement tool from the memory and cause the display surface to redisplay the virtual measurement tool to the user while the user occupies the second environment, including spatially associating the virtual measurement tool with an object in the second environment.
